(19) United States
(12) Patent Application Publication
(10) Pub. No.: US 2009/0237540 A1
(43) Pub. Date: Sep. 24, 2009

(54) Imager method and apparatus having combined gate signals

(75) Inventor: Richard S. Johnson, Boise, ID (US)

Correspondence Address: DICKSTEIN SHAPIRO LLP, 1825 EYE STREET NW, Washington, DC, 20006-5403, US

(73) Assignee: MICRON TECHNOLOGY, INC.

(21) Appl. No.: 12/076,632

(22) Filed: Mar. 20, 2008

(51) Int. Cl. H04N 3/15; H04N 5/335

(52) U.S. Cl. 348/308; 348/302; 348/E03.021

(57) ABSTRACT

An imaging device and method for operating the device. The device comprises a pixel array having a plurality of pixels arranged in rows and columns and a plurality of readout circuits for the pixels. A reset circuit in one readout circuit is simultaneously operated with a dual conversion gain select circuit in another readout circuit using a common select line. Alternatively, a row circuit in one readout circuit is simultaneously operated with a dual conversion gain select circuit in another readout circuit using a common select line.

### FIELD OF THE INVENTION

Embodiments described herein relate generally to imaging devices having pixel arrays with pixels containing reset, row and dual conversion gain transistors

### BACKGROUND OF THE INVENTION

Many portable electronic devices, such as cameras, cellular telephones, Personal Digital Assistants (PDAs), MP3 players, computers, and other devices include an imaging device for capturing images. One example of an imaging device is a CMOS imaging device. A CMOS imaging device includes a focal plane array of pixels, each one of the pixels including a photosensor, for example, a photogate, photoconductor or a photodiode overlying a substrate for accumulating photo-generated charge in the underlying portion of the substrate. Each pixel has a readout circuit that includes at least an output field effect transistor and a charge storage region connected to the gate of the output transistor. The charge storage region may be constructed as a floating diffusion region. Each pixel may include at least one electronic device such as a transistor for transferring charge from the photosensor to the storage region and one device, also typically a transistor, for resetting the storage region to a predetermined charge level prior to charge transference, and a row select transistor for selectively connecting the pixel to a column line. The pixel may also contain a dual conversion gain transistor connected to a capacitor for increasing the conversion gain of the pixel.

In a CMOS imaging device, the active elements of a pixel perform the necessary functions of: (1) photon to charge conversion; (2) accumulation of image charge; (3) resetting the storage region to a known state; (4) transfer of charge to the storage region accompanied by charge amplification; (5) selection of a pixel for readout; and (6) output and amplification of a signal representing a reset level and pixel charge. Photo charge is converted to a voltage at the as it moves from the initial charge accumulation region to the storage region. The source follower transistor transfers the stored voltage to a pixel output signal.

FIG. 1 illustrates a typical five-transistor pixel 50 utilized in a pixel array of an imaging device, such as a CMOS imaging device. The pixel 50 includes a photosensor 52 (e.g., photodiode, photogate, etc.), transfer transistor 54, and readout circuit 51. The readout circuit 51 includes a storage node configured as a floating diffusion region N, reset transistor 56, dual conversion gain transistor 62, capacitor C, source follower transistor 58 and row select transistor 60. The photosensor 52 is connected to the floating diffusion region N by the transfer transistor 54 when the transfer transistor 54 is activated by transfer select line 53 carrying a transfer select signal TXₙ. The reset transistor 56 is connected between the floating diffusion region N and an array pixel supply voltage Vₐₐₚᵢₓ. The dual conversion gain transistor 62 connects a capacitor C to the floating diffusion region N when a dual conversion gain signal DCG is applied to the gate of the dual conversion gain transistor 62. A reset signal RST supplied over a reset select line 57 is used to activate the reset transistor 56, which resets the floating diffusion region N and capacitor C, if the dual conversion gain transistor is activated, to a known state as is known in the art.

The source follower transistor 58 has its gate connected to the floating diffusion region N and is connected between the array pixel supply voltage Vₐₐₚᵢₓ and the row select transistor 60. The source follower transistor 58 transfers the charge stored at the floating diffusion region N as an output signal. The row select transistor 60 is controllable by a row select signal ROW supplied over a row select line 61 for selectively outputting the output signal OUT from the source follower transistor 58 to sample and hold circuit 46 via column line 45. For each pixel 50, two output signals are conventionally generated, one being a reset signal Vᵣₛₜ generated after the floating diffusion region N is reset, the other being an image or photo signal V_{sig} generated after charges are transferred from the photosensor 52 to the floating diffusion region N. Output signals Vᵣₛₜ,V_{sig} are selectively stored in the sample and hold circuit 46 based on reset and pixel sample and hold select signals SHR, SHS.

Conventional CMOS imager designs, such as that shown in FIG. 1 for pixel 50, provide only approximately a fifty percent fill factor, meaning only half of the pixel 50 layout area comprises a photosensor utilized in converting light to electric charge. The remainder of the pixel 50 includes the transfer transistor 54 and the readout circuit 51. As the total pixel area continues to decrease due to desired scaling, it becomes increasingly important to create photosensors that utilize as much of the pixel surface area as possible to increase quantum efficiency.

Accordingly, there is a desire for a pixel array architecture which has an improved fill factor and increased quantum efficiency.

### BRIEF DESCRIPTION OF THE DRAWINGS

FIG. 1 illustrates a five-transistor pixel for use in an array of an imaging device.

FIG. 2 is a diagram of a five-transistor pixel with combined reset and dual conversion gain gates according to an embodiment described herein.

FIG. 3 is a diagram of a portion of a pixel array with combined reset and dual conversion gain gates according to an embodiment described herein.

FIG. 4a is a timing diagram depicting an example of a method for operating a pixel array constructed according to an embodiment described herein.

FIG. 4b is a timing diagram depicting an example of a method for operating a pixel array constructed according to an embodiment described herein.

FIG. 5 is a diagram of a portion of a pixel array with combined row-select and dual conversion gain gates according to an embodiment described herein.

FIG. 6a is a timing diagram depicting an example of a method of operating a pixel array constructed in according to an embodiment described herein.

FIG. 6b is a timing diagram depicting an example of a method of operating a pixel array constructed in according to an embodiment described herein.

FIG. 7 is a block diagram of an imaging device according to an embodiment described herein.

FIG. 8 is a block diagram of a system according to an embodiment described herein.

### DETAILED DESCRIPTION OF THE INVENTION

In the following detailed description, reference is made to various embodiments that are described with sufficient detail to enable those skilled in the art to practice them. It is to be understood that other embodiments may be employed, and that various structural, logical and electrical changes may be made. The progression of processing steps described is only an example of embodiments that may be practiced; however, the sequence of steps is not limited to that set forth herein and may be changed as is known in the art, with the exception of steps necessarily occurring in a certain order.

Various embodiments described herein relate to a method and apparatus for reduced metal routing in an imager by combining the select line routing for the gates of the reset and dual conversion gain transistors of aligned pixels or combining the select line routing for the gates of the row and dual conversion gain transistors of aligned pixels. By connecting the gates of reset and dual conversion gain transistors or the gates of the row and dual conversion gain transistors of aligned pixels, metal lines are reduced, allowing for more area for the photosensor and an increase in quantum efficiency. Furthermore, various embodiments discussed below include pixel arrays having pixel layouts in which multiple pixels share a readout circuit and in which the gates of reset and dual conversion gain transistors or the gates of the row and dual conversion gain transistors of the readout circuits of different multiple pixel circuits have a combined select line. Additionally, various embodiments described herein also relate to a method and apparatus for reducing the die size in row driver circuits and reducing the power consumption.

The term “pixel,” as used herein, refers to a photo-element unit cell containing at least a photosensor for converting photons to an electrical signal. For purposes of illustration, a small number of representative pixels are illustrated in the figures and description herein; however, typically fabrication of a large plurality of like pixels proceeds simultaneously. Accordingly, the following detailed description is not to be taken in a limiting sense, and the scope of the present invention is defined only by the appended claims.

The subscripts that are used with the transistor select lines herein are used to delineate the pixel to which the signal is be applied. If a signal activates more than one transistor, the subscripts designate which pixel is activated by that signal.

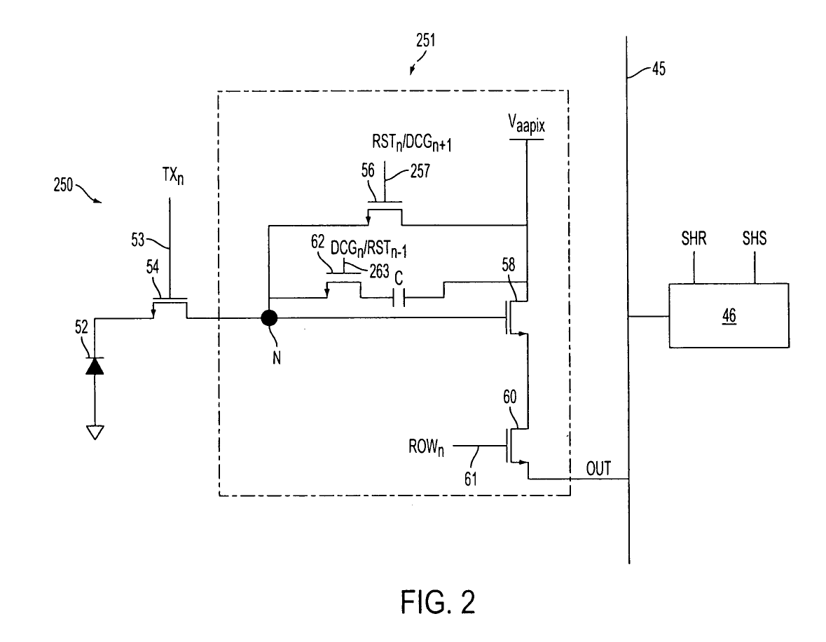

Now referring to the figures, where like reference numbers designate like elements, FIG. 2 illustrates an example of a pixel 250 constructed in accordance with a first embodiment. The pixel 250 includes a photosensor 52 (e.g., photodiode, photogate, etc.), transfer transistor 54, and readout circuit 251. The readout circuit 251 includes a storage region configured as a floating diffusion region N, reset transistor 56, source follower transistor 58, dual conversion gain transistor 62, and row select transistor 60. The photosensor 52 is connected to the floating diffusion region N by the transfer transistor 54 when the transfer transistor 54 is activated by transfer select line 53 carrying a transfer select signal TXₙ which turns transfer transistor 54 on. The reset transistor 56 is connected between the floating diffusion region N and an array pixel supply voltage Vₐₐₚᵢₓ. A reset signal RSTₙ supplied over a reset select line 257 is used to activate the reset transistor 56, which resets the floating diffusion region N to a known state as is known in the art. The dual conversion gain transistor 62 is connected between the floating diffusion region N and a capacitor C. The capacitor C is connected to Vₐₐₚᵢₓ. A dual conversion gain select signal DCGₙ is supplied over a dual conversion gain select line 263, which connects capacitor C to the floating diffusion region N to allow for the additional collection of charge (i.e., dual conversion gain). The capacitor C is also reset when the RSTₙ signal is supplied and the dual conversion gain transistor is enabled.

The source follower transistor 58 has its gate connected to the floating diffusion region N and is connected between the array pixel supply voltage Vₐₐₚᵢₓ and the row select transistor 60. The source follower transistor 58 transfers the charge stored at the floating diffusion region N as an output signal. The row select transistor 60 is controllable by a row select signal ROWₙ supplied over a row select line 61 for selectively outputting the output signal OUT from the source follower transistor 58 to sample and hold circuit 46 via column line 45. For each pixel 250, two output signals are conventionally generated, one being a reset signal Vᵣₛₜ generated after the floating diffusion region N is reset, the other being an image or photo signal V_{sig} generated after charges are transferred from the photosensor 52 to the floating diffusion region N. Output signals Vᵣₛₜ,V_{sig} are selectively stored in the sample and hold circuit 46 based on reset and pixel sample and hold signals SHR, SHS.

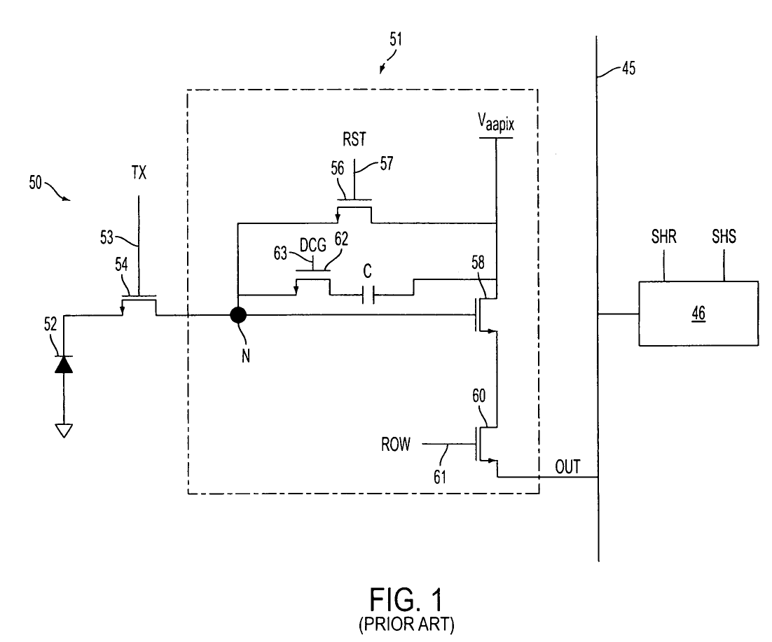

A pixel array is formed comprising a plurality of FIG. 2 pixels that are arranged in rows and columns. Pixel 250 is identical to pixel 50 (FIG. 1), except that the dual conversion gain line 236 for a pixel in a current row “n” is combined with a reset line 257 for a pixel 250 in a previous row “n−1”. Under such a configuration, dual conversion gain select line 263 carries a signal that is a dual conversion gain signal DCGₙ for the current pixel 250 (i.e., row n) as well as a reset signal RSTₙ₋₁ for a pixel in a previous row (i.e., row n−1). Moreover, the reset line 257 is combined with a dual conversion gain line for a pixel 250 in a following row. Under such a configuration, the reset line 257 carries a signal that is a reset signal RSTₙ for the current pixel 250 (i.e., row n) as well as a dual conversion gain signal DCGₙ₊₁ for a pixel in a following row (i.e., row n+1).

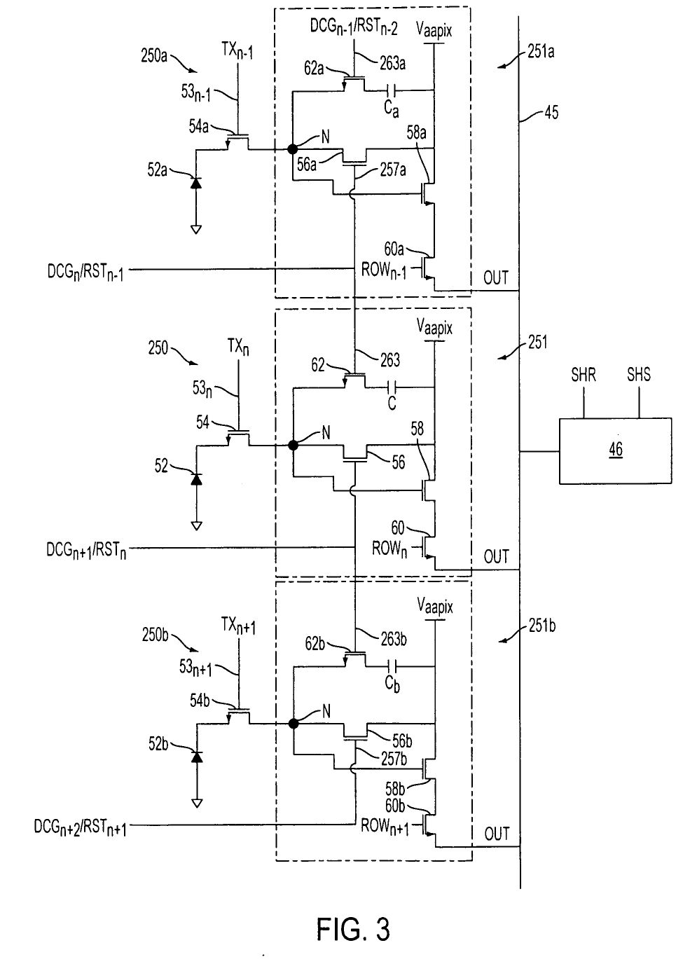

FIG. 3 is an expanded view of the pixel 250 of FIG. 2 which is shown connected to a vertically adjacent pixel 250a in a previous row n−1, and a vertically adjacent pixel 250b in a following row n+1. The dual conversion gain select line 263 of pixel 250 and the reset select line 257a of pixel 250a are common pixel elements (i.e., they are shared). The dual conversion gain select line 263b of pixel 250b iand the reset select line 257 are also common pixel elements. While the embodiments shown herein illustrate adjacent pixels, it should be understood that the pixels need not be vertically adjacent but can be vertically separated by any number of pixels. The pixels, however, cannot share the same row. Although FIG. 3 illustrates a non-shared pixel architecture, the combined dual conversion gain and reset gates can also be implemented using a common element pixel architecture (i.e., 2 or 4 way shared pixel).

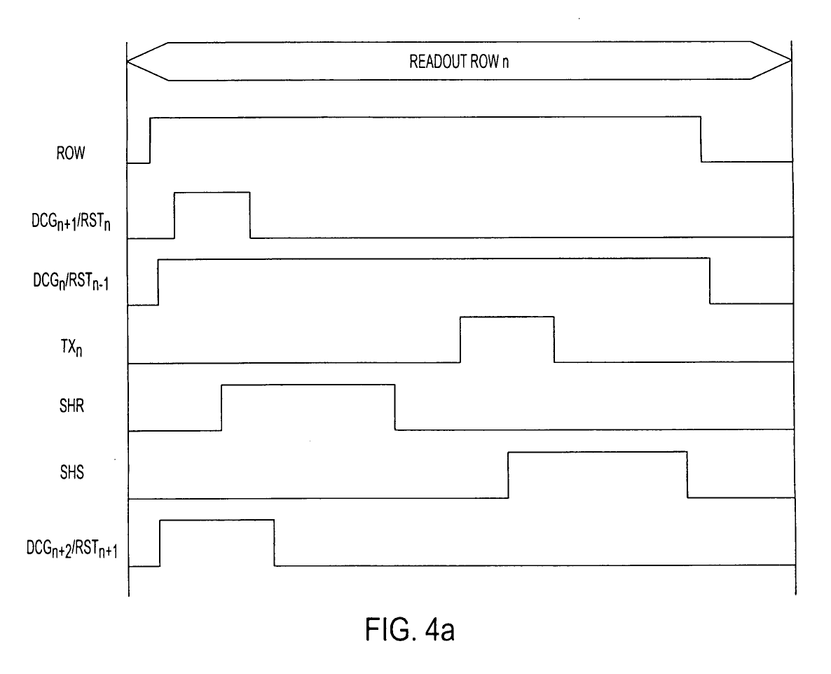

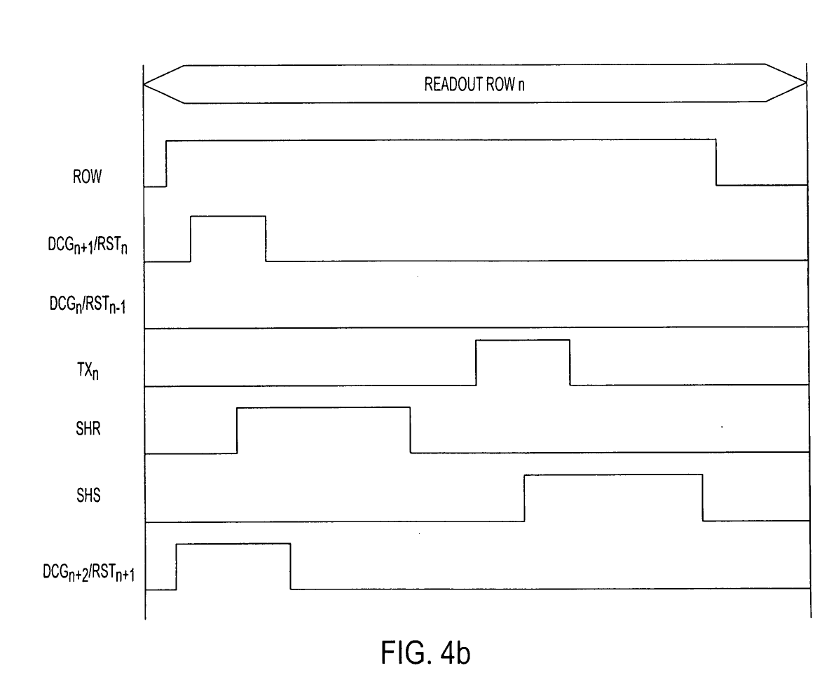

FIGS. 4a and 4b respectively illustrate pixel signal readout timing using a low conversion gain and a high conversion gain in pixel 250. Specifically, FIG. 4a illustrates a readout timing for a current row n using a low conversion gain. Initially, the row in which the pixel 250 resides is selected upon the activation of the row select signal ROWₙ. The dual conversion gain transistor is turned on by DCGₙ/RSTₙ₋₁, which connects the charge handling capacitance of capacitor C to the floating diffusion region N. The floating diffusion region N and capacitor C of the activated row are reset by turning on the reset transistor 56 with a DCGₙ₊₁/RSTₙ pulse. Once the RSTₙ signal is inactive, pixel reset signal Vᵣₛₜ is output by the source follower transistor 58 through the row select transistor 60 to column line 45. The signal is routed to sample and hold circuit 46, which samples and holds the new signal Vᵣₛₜ when the sample and hold select signal SHR is activated. The reset transistor 56b of row n+1 is also activated by signal DCGₙ₊₂/RSTₙ₊₁ to reset pixel 250b to prevent blooming on the node between Cb and 62b.

Also, when the reset select signal RSTₙ for the current pixel 250 becomes inactive, the current pixel 250, which has been integrating charge in photosensor 52 after a prior pixel read, transfers the integrated photoelectric charge to the floating diffusion region N and capacitor C when the transfer select signal TXₙ of the current pixel 250 is activated. This photoelectric charge is transferred as the photo signal V_{sig} at the output of the source follower transistor 58 through row select transistor 60 to column line 45. Column line 45 routes the signal to the sample and hold circuit 46 which samples and holds the photo signal V_{sig} when the pixel signal sample and hold select signal SHS is activated, because the row select signal ROWₙ of the current pixel 250 is active.

FIG. 4b illustrates a readout timing for a current row using a high conversion gain. Initially, the row in which the pixel 250 resides is selected upon the activation of the row select signal ROWₙ. The dual conversion gain transistor is not turned on by signal DCGₙ/RSTₙ₋₁ so the charge handling capacitance of capacitor C is not connected to the floating diffusion region N. The floating diffusion region N of the activated row is reset by turning on the reset transistor 56 with a DCGₙ₊₁/RSTₙ pulse. Once the RSTₙ signal is inactive, pixel reset signal Vᵣₛₜ is output by the source follower transistor 58 through the row select transistor 60 to column line 45. The signal is routed to sample and hold circuit 46, which samples and holds the new signal Vᵣₛₜ when the sample and hold select signal SHR is activated. The reset transistor 62b of row n+1 is also activated by signal DCGₙ₊₂/RSTₙ₊₁ to reset pixel 250b to prevent blooming on the node between Cb and 62b.

Also, when the reset select signal RSTₙ for the current pixel 250 becomes inactive, the current pixel 250, which has been integrating charge in photosensor 52 after a prior pixel read, transfers the integrated photoelectric charge to the floating diffusion region N when the transfer select signal TXₙ of the current pixel 250 is activated. This photoelectric charge is transferred as the photo signal V_{sig} at the output of the source follower transistor 58 through row select transistor 60 to column line 45. Column line 45 routes the signal to the sample and hold circuit 46 which samples and holds the photo signal V_{sig} when the pixel signal sample and hold select signal SHS is activated, because the row select signal ROWₙ of the current pixel 250 is active.

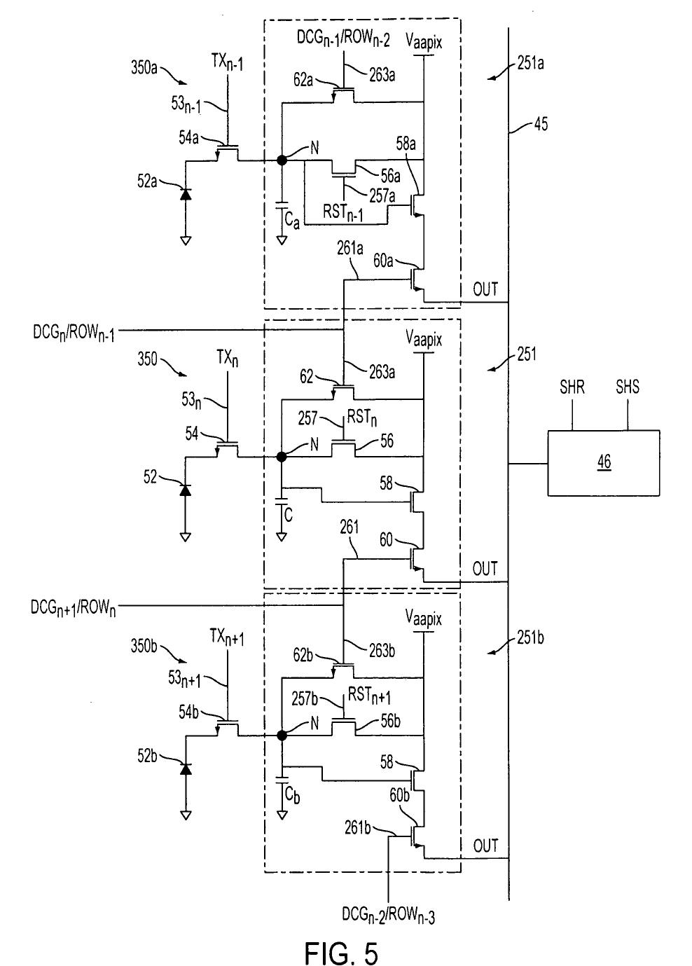

The pixels 350a, 350, 350b of FIG. 5 are identical to pixel 50 (FIG. 1), except that the dual conversion gain line 236 for a pixel in a current row “n” is combined with a row line 261 for a pixel 350 in a previous row “n−1”. Under such a configuration, dual conversion gain select line 263 carries a signal that is a dual conversion gain signal DCGₙ for the current pixel 350 (i.e., row n) as well as a reset signal ROWₙ₋₁ for a pixel in a previous row (i.e., row n−1). Moreover, the row line 261 is combined with a dual conversion gain line for a pixel 350 in a following row. Under such a configuration, the row line 261 carries a signal that is a row signal ROWₙ for the current pixel 350 (i.e., row n) as well as a dual conversion gain signal DCGₙ₊₁ for a pixel in a following row (i.e., row n+1).

FIG. 5 illustrates pixel 350 which is shown connected to a vertically adjacent pixel 350a in a previous row n−1, and a vertically adjacent pixel 350b in a following row n+1. The dual conversion gain select line 263 of pixel 350 and the row select line 261a of pixel 350a are common pixel elements. The dual conversion gain select line 263b of pixel 250b and the row select line 261 are common pixel elements. While the embodiments here show adjacent pixels, it should be understood that the pixels need not be vertically adjacent but can be vertically separated by any number of pixels. The pixels, however, cannot share the same row. Although FIG. 5 illustrates a non-shared pixel architecture, the combined dual conversion gain and row gates can also be implemented using a common element pixel architecture (i.e., 2 or 4 way shared pixel).

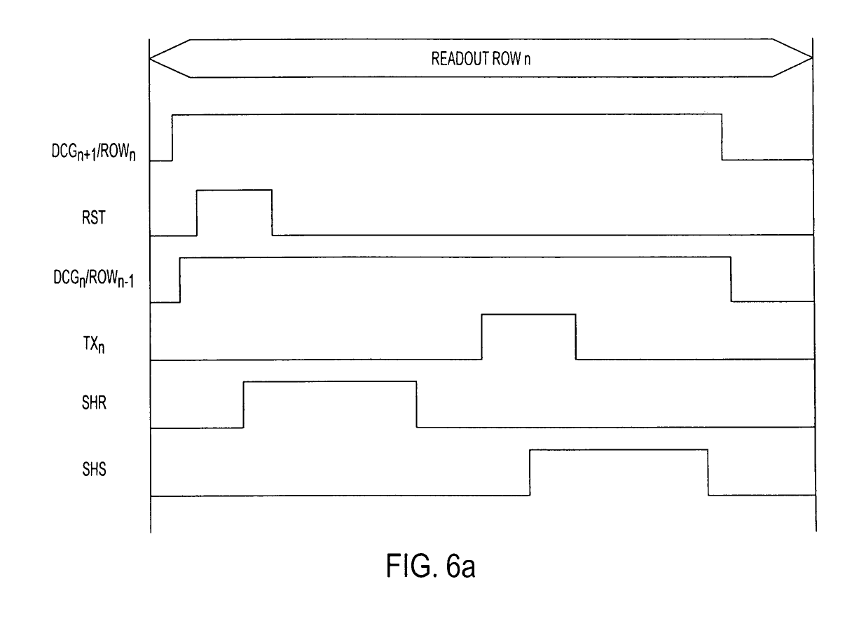

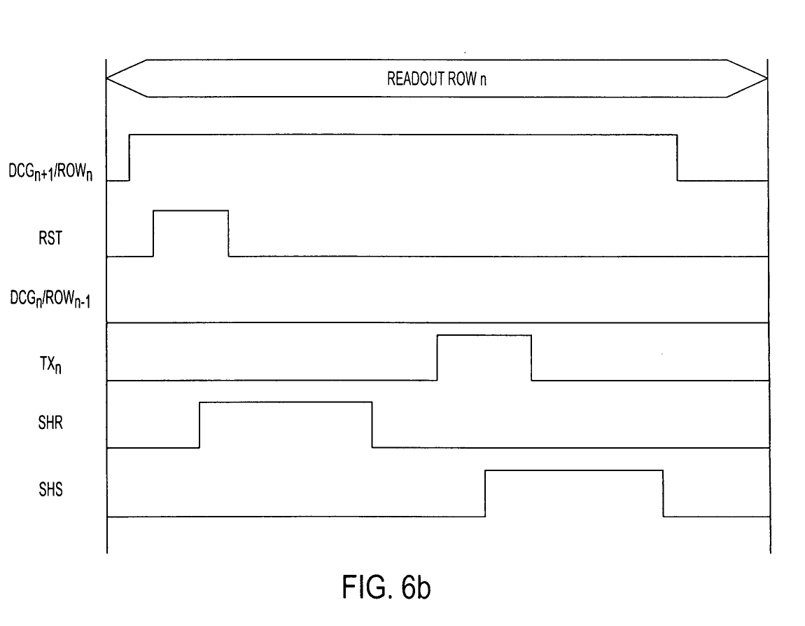

FIGS. 6a and 6b respectively illustrate pixel signal readout timing using a low conversion gain and a high conversion gain in pixel 350. Specifically, FIG. 6a illustrates a readout timing for a current row n using a low conversion gain. Initially, the row in which the pixel 350 resides is selected upon the activation of the row select signal DCGₙ₊₁/ROWₙ. The dual conversion gain transistor is turned on by DCGₙ/ROWₙ₋₁, which connects the charge handling capacitance of capacitor C to the floating diffusion region N. The floating diffusion region N and capacitor C of the activated row are reset by turning on the reset transistor 56 with a RSTₙ pulse. Once the RSTₙ signal is inactive, pixel reset signal Vᵣₛₜ is output by the source follower transistor 58 through the row select transistor 60 to column line 45. The signal is routed to sample and hold circuit 46, which samples and holds the new signal Vᵣₛₜ when the sample and hold select signal SHR is activated.

Also, when the reset select signal RSTₙ for the current pixel 350 becomes inactive, the current pixel 350, which has been integrating charge in photosensor 52 after a prior pixel read, transfers the integrated photoelectric charge to the floating diffusion region N when the transfer select signal TXₙ of the current pixel 350 is activated. This photoelectric charge is transferred as the photo signal V_{sig} at the output of the source follower transistor 58 through row select transistor 60 to column line 45. Column line 45 routes the signal to the sample and hold circuit 46 which samples and holds the photo signal V_{sig} when the pixel signal sample and hold select signal SHS is activated, because the row select signal DCGₙ₊₁ROWₙ of the current pixel 350 is active.

FIG. 6b illustrates a readout timing for a current row using a high conversion gain. Initially, the row in which the pixel 350 resides is selected upon the activation of the row select signal DCGₙ₊₁/ROWₙ. The dual conversion gain transistor is not turned on by signal DCGₙ/ROWₙ₋₁ so the charge handling capacitance of capacitor C is not connected to the floating diffusion region N. The floating diffusion region N and capacitor C of the activated row are reset by turning on the reset transistor 56 with a RSTₙ pulse. Once the RSTₙ signal is inactive, pixel reset signal Vᵣₛₜ is output by the source follower transistor 58 through the row select transistor 60 to column line 45. The signal is routed to sample and hold circuit 46, which samples and holds the new signal Vᵣₛₜ when the sample and hold select signal SHR is activated.

Also, when the reset select signal RSTₙ for the current pixel 350 becomes inactive, the current pixel 350, which has been integrating charge in photosensor 52 after a prior pixel read, transfers the integrated photoelectric charge to the floating diffusion region N when the transfer select signal TXₙ of the current pixel 350 is activated. This photoelectric charge is transferred as the photo signal V_{sig} at the output of the source follower transistor 58 through row select transistor 60 to column line 45. Column line 45 routes the signal to the sample and hold circuit 46 which samples and holds the photo signal V_{sig} when the pixel signal sample and hold select signal SHS is activated, because the row select signal DCGₙ₊₁/ROWₙ of the current pixel 350 is active

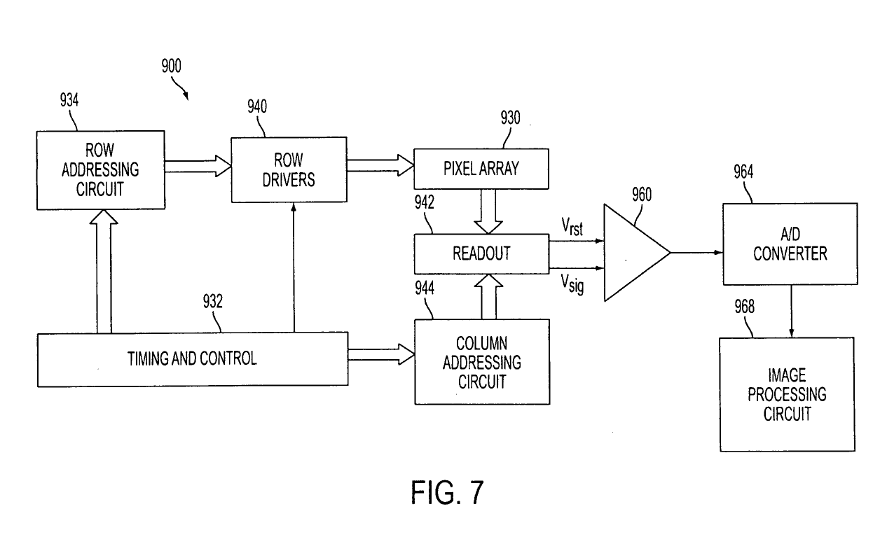

FIG. 7 illustrates a block diagram of an example of a CMOS imager 900 having a pixel array 930 being constructed in accordance with one of the embodiments described above. Pixel array 930 comprises a plurality of pixels arranged in a predetermined number of columns and rows. The pixels of each row in array 930 are operated by row t lines, and the pixels of each column are selectively output by respective column lines. A plurality of row and column lines are provided for the entire array 930. The row lines are selectively activated by a row driver 940 in response to row address circuit 934. The column lines are selectively activated by a column addressing circuit 944. Thus, a row and column address is provided for each pixel. The pixel signals Vᵣₛₜ, V_{sig} read out from each pixel are subtracted in differential amplifier 960 and are converted to digital signals by analog-to-digital converter 964 which supplies the digital signal to an image processing circuit which processes each pixel signal and forms an image which can be displayed, stored, or output.

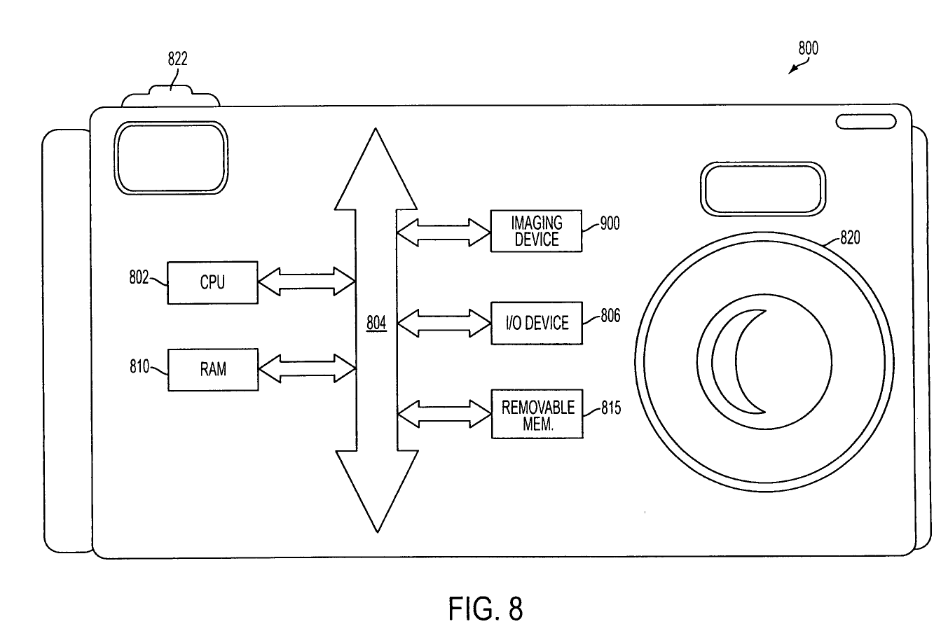

FIG. 8 shows a typical system 800 modified to include an imaging device 900 constructed and operated in accordance with an embodiment. The system 800 is a system having digital circuits that could include imaging devices. Without being limiting, such a system could include a computer system, camera system, scanner, machine vision, vehicle navigation, video phone, surveillance system, auto focus system, star tracker system, motion detection system, image stabilization system, or other image acquisition system.

System 800, for example a digital still or video camera system, generally comprises a central processing unit (CPU) 802, such as a control circuit or microprocessor for conducting camera functions, that communicates with one or more input/output (I/O) devices 806 over a bus 804. Imaging device 900 also communicates with the CPU 802 over the bus 804. The processor system 800 also includes random access memory (RAM) 810, and can include removable memory 815, such as flash memory, which also communicates with the CPU 802 over the bus 804. The imaging device 900 may be combined with the CPU processor with or without memory storage on a single integrated circuit or on a different chip than the CPU processor. In a camera system, a lens 820 is used to focus light onto the pixel array 930 of the imaging device 900 when a shutter release button 822 is pressed.

The above description and drawings are only to be considered illustrative of specific embodiments, which achieve the features and advantages described herein. Modification and substitutions to specific structures can be made. Accordingly, the claimed invention is not to be considered as being limited by the foregoing description and drawings, but is only limited by the scope of the appended claims.

What is claimed as new and desired to be protected by Letters Patent of the United States is:

1. An imaging device, comprising:
a pixel array having a plurality of pixels arranged in rows and columns, each pixel of the array comprising at least a photosensor;
a plurality of pixel readout circuits each associated with at least one pixel, the pixel readout circuit comprising:
a storage node for receiving charges from a photo sensor;
a reset circuit responsive to a reset control signal for resetting the storage node;
a circuit for providing an output signal based on charges stored at the storage node;
a dual conversion gain circuit responsive to a dual conversion gain signal for selectively coupling the storage node to a capacitor; and
a select line for commonly providing a reset control signal to the reset circuit and a dual conversion gain signal to a dual conversion gain circuit of a different pixel readout circuit.

2. The imaging device of claim 1, wherein each pixel readout circuit is respectively associated with one pixel.

3. The imaging device of claim 1, wherein each pixel readout circuit is respectively associated with a plurality of pixels.

4. An imaging device, comprising:
a pixel array comprising a plurality of pixels arranged in rows and columns, at least one pixel in a first row of the array comprising:
a photosensor;
a floating diffusion region for storing photoelectric charge supplied by the photosensor;
a source follower transistor having a gate coupled to the floating diffusion region;
a reset transistor for resetting the floating diffusion region, the reset transistor having a gate coupled to a first reset select line; and
a dual conversion gain transistor for switchably coupling additional storage capacity to the floating diffusion region, the dual conversion gain transistor having a gate coupled to a second reset select line of a pixel in a second row following the first row.

5. The imaging device of claim 4, wherein the first reset select line is coupled to a gate of a dual conversion gain transistor of a third row previous to the first row.

6. The imaging device of claim 5, wherein the second and third rows are vertically adjacent the first row.

7. The imaging device of claim 4, wherein the additional storage capacity is a capacitor.

8. The imaging device of claim 4, wherein the floating diffusion region is arranged to receive charges from more than one associated pixel.

9. The imaging device of claim 4, further comprising a transfer transistor switchably coupling the photosensor to the floating diffusion region.

10. The imaging device of claim 4, further comprising a row transistor responsive to a row select signal for selectively coupling the pixel to a column line.

11. An imaging device, comprising:
a pixel array comprising:
a plurality of pixels arranged in rows and columns, each pixel comprising a photosensor; and
a plurality of readout circuits arranged in rows and columns, at least one readout circuit in a readout circuit row of said array comprising:
a floating diffusion region for storing a photoelectric charge supplied by at least one photosensor,
a source follower transistor having a gate coupled to the floating diffusion region, and
a reset transistor for resetting the floating diffusion region, the reset transistor having a gate coupled to a reset select line; and
a dual conversion gain transistor for switchably coupling a capacitance to the floating diffusion region, the dual conversion gain transistor to having a gate coupled to a reset select line of a readout circuit in a different readout circuit row.

12. The imaging device of claim 11, wherein the reset select line is coupled to a gate of a dual conversion transistor in a readout circuit of a next readout circuit row previous to the readout circuit row.

13. The imaging device of claim 11, wherein the gate of the dual conversion gain transistor is coupled to a gate of a reset transistor in a readout circuit of a next readout circuit row following the readout circuit row.

14. The imaging device of claim 11, wherein the next readout circuit row following the readout circuit row is a vertically adjacent row.

15. The imaging device of claim 11, wherein the next readout circuit row following the readout circuit row is not a vertically adjacent row.

16. The imaging device of claim 11, wherein each pixel further comprises a plurality of transfer transistors for switchably coupling the photosensors to the floating diffusion region, said transfer transistors being controlled by transfer select lines, each transfer select line controlling one transfer transistor coupled to the floating diffusion region.

17. A method of operating a pixel circuit, the method comprising:
activating a first select line coupled to a pixel readout circuit in a first row to activate a dual conversion gain transistor in the readout circuit in the first row and simultaneously activate a reset transistor in a readout circuit in a previous row.

18. The method of claim 17 further comprising activating a transfer select line to transfer a photoelectric charge from at least one pixel to the readout circuit.

19. The method of claim 17 further comprising:
activating a second select line coupled to the readout circuit in the first row to activate a reset transistor in the readout circuit in the first row and to simultaneously activate a dual conversion gain transistor in a readout circuit in a following row.

20. The method of claim 17, wherein the readout circuit is arranged to receive charges from a plurality of associated pixels.

21. The method of claim 17, wherein the readout circuit is arranged to receive charges from one associated pixel.

22. An imaging device comprising:
a first readout circuit associated with a first pixel, the first readout circuit having a reset circuit that resets a first storage location in response to a reset signal; and
a second readout circuit associated with a second pixel, the second readout circuit having a gain circuit that couples a second storage location to a capacitor in response to the reset signal.

23. The imaging device according to claim 22, wherein said first and second readout circuits each further comprise a circuit for providing an output signal based on charges stored the first and second storage locations, respectively.

24. An imaging device, comprising:
a pixel array comprising a plurality of pixels arranged in rows and columns, at least one pixel in a first row of the array comprising:
a photosensor;
a floating diffusion region for storing photoelectric charge supplied by the photosensor;
a row select transistor for selectively connecting the pixel to a column line, the row transistor having a gate coupled to a first row select line; and
a dual conversion gain transistor for switchably coupling additional storage capacity to the floating diffusion region, the dual conversion gain transistor having a gate coupled to a second row select line of a pixel in a second row following the first row.

25. The imaging device of claim 24, wherein the first reset select line is coupled to a gate of a dual conversion gain transistor of a third row previous to the first row.

26. The imaging device of claim 25, wherein the second and third rows are vertically adjacent the first row.

27. The imaging device of claim 24, wherein the floating diffusion region is arranged to receive charges from more than one associated pixel.

28. The imaging device of claim 24, further comprising a transfer transistor switchably coupling the photosensor to the floating diffusion region.

29. The imaging device of claim 24, further comprising a reset transistor responsive to a reset select signal for selectively resetting the floating diffusion region.

30. An imaging device comprising:
a first readout circuit associated with a first pixel, the first readout circuit having a row select circuit that connects the first pixel to a first column line in response to a row signal; and
a second readout circuit associated with a second pixel, the second readout circuit having a gain circuit that couples a second storage location to a capacitor in response to the row signal.

31. The imaging device according to claim 30, wherein said first and second readout circuits each further comprise a reset circuit that resets the first and second storage location in response to a reset signal, respectively.

32. A method of operating a pixel circuit, the method comprising:
activating a first select line coupled to a pixel readout circuit in a first row to activate a dual conversion gain transistor in the readout circuit in the first row and simultaneously activate a row transistor in a readout circuit in a previous row.

33. The method of claim 32 further comprising activating a transfer select line to transfer a photoelectric charge from at least one pixel to the readout circuit.

34. The method of claim 32 further comprising:
activating a second select line coupled to the readout circuit in the first row to activate a row transistor in the readout circuit in the first row and to simultaneously activate a dual conversion gain transistor in a readout circuit in a following row.

35. The method of claim 32, wherein the readout circuit is arranged to receive charges from a plurality of associated pixels.

36. The method of claim 32, wherein the readout circuit is arranged to receive charges from one associated pixel.
